(19) United States
(12) Patent Application Publication
(10) Pub. No.: US 2026/0157531 A1
(43) Pub. Date: Jun. 11, 2026

(54) PILLOW ADJUSTMENT MECHANISM

(71) Applicant: Peter Podirsky, Forrestfield (AU)

(72) Inventor: Peter Podirsky, Forrestfield (AU)

(21) Appl. No.: 18/979,821

(22) Filed: Dec. 13, 2024

(30) Foreign Application Priority Data
Dec. 10, 2024 (AU) 2024278278

(51) Int. Cl. A47C 21/02; A61G 7/05

(52) U.S. Cl. CPC A47C 21/026; A61G 7/0503

(57) ABSTRACT

A pillow adjustment mechanism (10) comprising a replaceable sleeve (14) for holding a pillow (12); at least one strip (16) connected to the replaceable sleeve (14); and a clamp (30) connected to the at least one strip (16) and having connection means (31,32) for connecting the clamp (30) to a furniture item (20), wherein the at least one strip (16) is connected to the clamp (30) at a selected position (S) corresponding with a selected position (S) of the pillow (12) relative to the furniture item (20). In preferred embodiments, the furniture item is a hospital bed (20).

### TECHNICAL FIELD

The present invention relates to a pillow adjustment mechanism.

### BACKGROUND

The following discussion of the background art is intended to facilitate an understanding of the present invention only. The discussion is not an acknowledgement or admission that any of the material referred to is or was part of the common general knowledge as at the priority date of the application.

Annoyance is caused to many hospital patients by pillow slippage, for example at a back section of a hospital bed. When the back section angle increases above a certain angle, the pillow slips down to an uncomfortable position for the patient. At the same time, the pillow being located under a patient's body may be difficult to retrieve and move back to a comfortable position. This takes time from nursing duties so is inefficient but may also present a risk of injury to a patient where even slight movements may make their current health condition worse.

It will be appreciated that the pillow slippage issue could also arise in situations other than hospitals, for example in beds or recliners located in homes or holiday resorts. A similar problem may also arise in chairs though these would not typically present the injury or inefficiency risks encountered in a hospital setting.

The present invention has been developed against the above background.

### BRIEF SUMMARY OF THE INVENTION

In a first aspect, the present invention provides a pillow adjustment mechanism comprising:
a replaceable sleeve for holding a pillow;
at least one strip connected to the replaceable sleeve; and
a clamp connected to the at least one strip and having connection means for connecting the clamp to a furniture item,
   wherein the at least one strip is connected to the clamp at a selected position corresponding with a selected position of the pillow relative to the furniture item.

The clamp preferably has a frictional grip with the furniture item and may be provided with a suitable shape, for example C, U or J shape to assist such grip. The clamp preferably has a degree of elasticity allowing it to be stretched sufficiently to accommodate a portion of the furniture item, for example a portion of a mattress, and then spring back to provide a neat or interference fit to the furniture item, for example enabling neat or interference fit to a mattress of a hospital bed.

The at least one strip may enable connection to the clamp at a plurality of selectable positions, each selectable position being spaced apart by a determined distance. The spacing of the selectable positions may be uniform. The positions may be fixed with the at least one strip being provided with a plurality of connectors connectable to the clamp. For example, the plurality of connectors disposed on the strip may comprise a number of spaced slots, for example of circular or quadrilateral geometry and the complementary connector disposed on the clamp may be a hook or other suitable connector. The arrangement could be reversed such that the hook was disposed on the at least strip, for example being spaced apart on the at least one strip and the slot on the clamp.

The sleeve may be connected to the at least one strip by any suitable connector, such as a button or stud which may be disposed on the strip, and engageable with a complementary connector disposed on the sleeve, e.g. a buttonhole or aperture, preferably located at the top of the sleeve. A number of such complementary connectors may be located on the sleeve to enable connection of, most conveniently a maximum of two or three strips. The sleeve may be provided with reinforcement, for example at the top of the sleeve, to provide strengthening at the complementary connector(s). If desired, the sleeve could also allow connection to the at least one strip at a selected position.

The at least one strip is preferably flexible allowing a small range of movement, on the order of centimetres, for the pillow. This may avoid discomfort due to an overly rigid positioning of the pillow.

The at least one strip may be disposed at an angle to the horizontal corresponding to the angle at which the furniture item, or section of the furniture item is inclined. For example, the at least one strip may be disposed at 0 to 75 degrees to a horizontal plane which may be represented by the top surface of a horizontally disposed body for supporting a person such as a mattress. This angular range corresponds with the desired range of inclination of the rear section of a hospital bed, for example a two crank or three crank hospital bed.

The replaceable nature of the sleeve allows it to be changed over when soiled or worn. The replaceable sleeve is desirably of a textile material, such as a soft fabric, which feels comfortable to the user by allowing enjoyment of the pillow and avoiding contact with a rigid material such as a metal frame.

The clamp may comprise at least one fitting, for example at least one hook, enabling connection of a member selected from the group consisting of a cable or tube forming part of a therapeutic system. For example, the cable may be an electrical cable providing power to medical equipment or a sensor cable directing signals between a sensor and medical equipment. The member may be a support for a container for administration of a liquid to a patient, for example by intravenous (IV) administration. Such liquids may include saline or pharmaceuticals.

The clamp may include a bracket for mounting the member. Adjustment means, such as wing nuts, may be provided for fixing the member in vertical position irrespective of the angle of inclination of the furniture item or furniture item section.

The furniture item is not limited to a hospital bed and may include beds, recliners or chairs for therapeutic, such as dental, or leisure purposes. In preferred embodiments, the furniture item is a hospital bed.

In a further aspect, the present invention provides a furniture item comprising:
a body, such as a mattress, having a rear section movable to a determined angle, the rear section having a front surface and a rear surface; and
a pillow adjustment mechanism comprising:
   a replaceable sleeve for holding a pillow;
   at least one strip connected to the replaceable sleeve; and
   a clamp connected to the at least one strip and having connection means for connecting the clamp to the body,
      wherein the at least one strip is connected to the clamp at a selected position corresponding with a selected position of the pillow relative to the front surface of the rear section.

The pillow adjustment mechanism and furniture item, preferably a bed, may include the features described earlier. Where the furniture item is a bed, preferably a hospital bed, the body is conveniently a mattress.

The pillow adjustment mechanism and furniture item allows the problem of pillow slippage to be avoided. Further, the problem is avoided without use of rigid metallic structures, such as steel structures, for holding a pillow that may cause discomfort to the patient and which may be more costly to fabricate. Further embodiments including fittings for members forming part of therapeutic systems allow these members to be installed in an efficient manner with a tidier and safer presentation for a hospital bed.

### BRIEF DESCRIPTION OF THE DRAWINGS

Further features of the pillow adjustment mechanism of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a top isometric view of a front surface of a rear section of a hospital bed including the pillow adjustment mechanism according to a first embodiment of the present invention

FIG. 2 is a rear isometric view of a rear surface of the rear section of the hospital bed of FIG. 1.

FIG. 3 subsection (a) is a detail rear view of the top of the rear surface of a bed including a pillow adjustment mechanism according to a second embodiment of the present invention.

FIG. 3 subsection (b) is a detail section view of the bed including the pillow adjustment mechanism as shown in FIG. 3 subsection (a).

FIG. 4 is a rear isometric view of the rear surface of the rear section of the hospital bed of FIG. 3 subsections (a) and (b).

The drawings are illustrative and not to scale.

### DETAILED DESCRIPTION

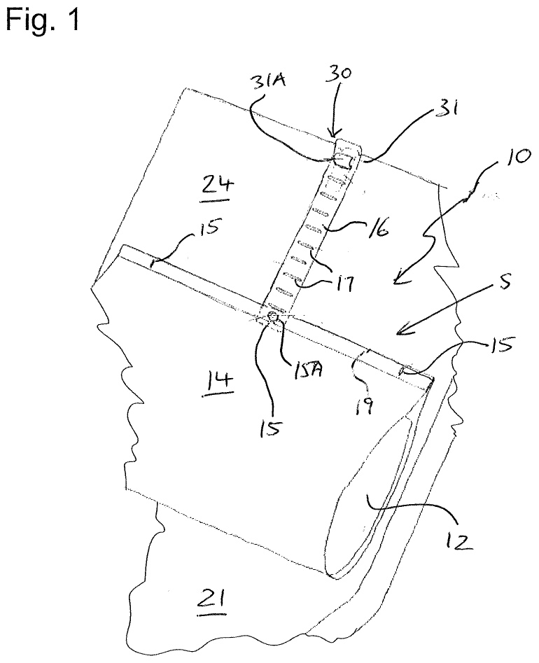

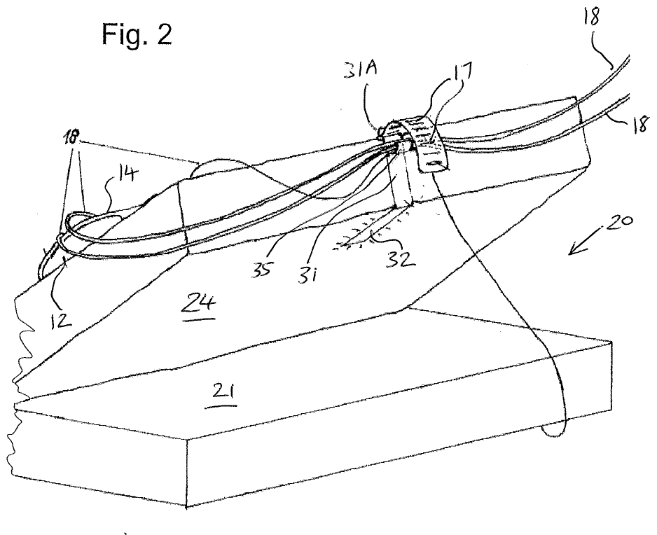

Referring to FIGS. 1 and 2, a pillow adjustment mechanism 10 provides a fixed selected position S for a pillow 12 on the front surface 22 of the rear section 24 of the mattress 21 of a two or three crank hospital bed 20. It will be understood that the pillow adjustment mechanism 10 could be fitted to furniture items other than hospital beds though this is a most preferred embodiment.

To achieve the fixed selected position S for pillow 12, the pillow adjustment mechanism 10 comprises a replaceable sleeve 14 for holding the pillow 12; at least one strip 16 connected to the replaceable sleeve 14; and a clamp 30 connected to the at least one strip 16 and having connection means 31, 32 for connecting the clamp 30 to the rear section 24 of hospital bed 20. The replaceable sleeve 14 is connected to the at least one strip 16 at the selected position S of the pillow 12 relative to the rear section 24.

Pillow 12 may be of any type used in a hospital setting and would generally provide support to the preference of a patient using hospital bed 20 or support as required as part of the therapy for the patient.

Rear section 24 of hospital bed 20 may be adjusted to a selected angle of inclination by a health care professional, for example using a crank located at the front of hospital bed 20 as known in the art. The angle of inclination may be in the range 0 to 75 degrees to a horizontal plane of a base section 26 of the mattress 21 of hospital bed 20. At higher acute angles, likely above 40 degrees, the pillow 12 could only be held in position by the patient's head (even this depending on the patient's medical state) and would typically slip down the rear section 24 causing discomfort to the patient in the absence of installation of pillow adjustment mechanism 10. If a health care professional needed solely to adjust the position of pillow 12, this would use up scarce time resources.

The replaceable nature of the sleeve 14 allows it to be changed over when soiled or worn. The replaceable sleeve 14 is desirably of a textile material like a soft fabric which feels comfortable to the user by allowing enjoyment of the pillow 12 and avoiding contact with a rigid material such as a metal frame. The replaceable sleeve 14 substantially surrounds pillow 12 which is not directly connected to the at least one strip 16.

The strip 16 is preferably formed of a flexible material, such as an elastomeric polymer, which has two advantages. First, such a flexible material allows a small range of movement, on the order of centimetres or inches, for the pillow 12. This acts to accommodate small patient movements and avoid patient discomfort due to an overly rigid positioning of the pillow 12. Second, the use of the flexible material avoids the use of a hard or overly rigid structure, such as a metallic member proximate to the pillow 12, towards which the pillow 12 would sag causing a hard sensation for the patient and consequential discomfort.

The flexible strip 16 is connected to the replaceable sleeve 14 by a button 15A connected through buttonhole 15 in the embodiment shown. Button 15A is conveniently located on flexible strip 16. However, other connectors such as toggles could be used. Strip 16 could be connected to the replaceable sleeve by complementary Velcro strips with a buckle being used to strengthen the connection if required.

Although one flexible strip 16 is shown in FIGS. 1 and 2, it may be necessary to provide a pair or more of such strips 16 in preferred embodiments to provide a level position for the pillow 12 and the desired stability. Sleeve 14 is provided with other button holes 15 to allow two or three flexible strips 16 to be connected to the sleeve 14, if required. It is likely impractical to provide more than three flexible strips 16 but the manufacturer can decide this.

The top of replaceable sleeve 14 is provided with a reinforcement layer 19, conveniently of textile polymeric or otherwise, to provide strengthening at the button holes 15 and greater assurance that the connection between sleeve 14 and flexible strip(s) 16 is maintained and not lost through tearing of the replaceable sleeve 14 at a potential weak point in the form of the button holes 15.

Strip 16 is provided with a plurality of uniformly spaced connectors in the form of rectangular slots 17. Connectors of other geometry could be used and need not be slots. The function of rectangular slots 17 is described further below. The rectangular slots 17 provide a plurality of selectable positions for connection to clamp 30, any of which may be selected dependent on patient preference or therapeutic requirement.

The clamp 30 frictionally grips the rear section 24 of hospital bed 20. The clamp 30, which may be of J, C or U shape and corresponding limbs 31, 32 being connection means in preferred embodiments, has a degree of elasticity allowing it to be stretched sufficiently to accommodate the top of the rear section 24 of the mattress 21 of the hospital bed 20 and then spring back to provide a neat or interference fit to the mattress 21 and hospital bed 20 with the limbs of the clamp 30 being spaced apart a dimension just smaller than the thickness of rear section 24 of mattress 21 which has a firm structure. Clamp 30 is preferably of a metallic material, such as spring steel which is pressed onto the firm rear section 24 of mattress 21. While a preferred embodiment, the clamp 30 could be fixed to rear section 24 in other ways, for example using fasteners. In other embodiments, clamp 30 could be a rigid structure and could comprise a plurality of clamp portions.

As can be seen from FIGS. 1 and 2, the clamp 30 is fitted at a spacing from the likely location of the patient's head on pillow 12 and so the metallic nature of clamp 30 is not expected to cause patient discomfort. It will also be understood that clamp 30 is not disposed proximate pillow 12 and does not provide a frame into which pillow 12 is fitted. This also avoids patient discomfort caused by contact of head with a hard metal structure.

Clamp 30 is provided with a hook 31A located at the top of rear section 24 of mattress 21. Hook 31A, which forms part of limb 31 of clamp 30, engages with a patient or health care professional selected rectangular slot 17 in strip 16 for firmly holding replaceable sleeve 14 and pillow 12 in the selected position S relative to the rear section 24 of mattress 21 of hospital bed 20. The pillow 12 may be moved up or down dependent on therapeutic requirements and patient preferences. As many positions for pillow 12 may be selected as there are rectangular slots 17 (or alternative connectors) in strip 16. Depending on the spacing between rectangular slots 17, the pillow 12 may be located at a range of positions relative to the rear section 24 providing flexibility in arrangement of pillow 12 relative to rear section 24. It will be appreciated that limb 31 or hook 31A could also be configured to provide alternative positions for strip 16, replaceable sleeve 14 and pillow 12.

Referring to FIG. 2, clamp 30 includes a further hook 35 providing a recess for cables 18 which may be sensor cables connected between the patient's body and medical equipment such as an electrocardiograph. This allows the sensor cables 18 to be located in an accessible position allowing easier adjustment and providing a tidier presentation for the hospital bed 20. Cables 18 may be replaced by tubes for administration of therapeutic liquids to a patient.

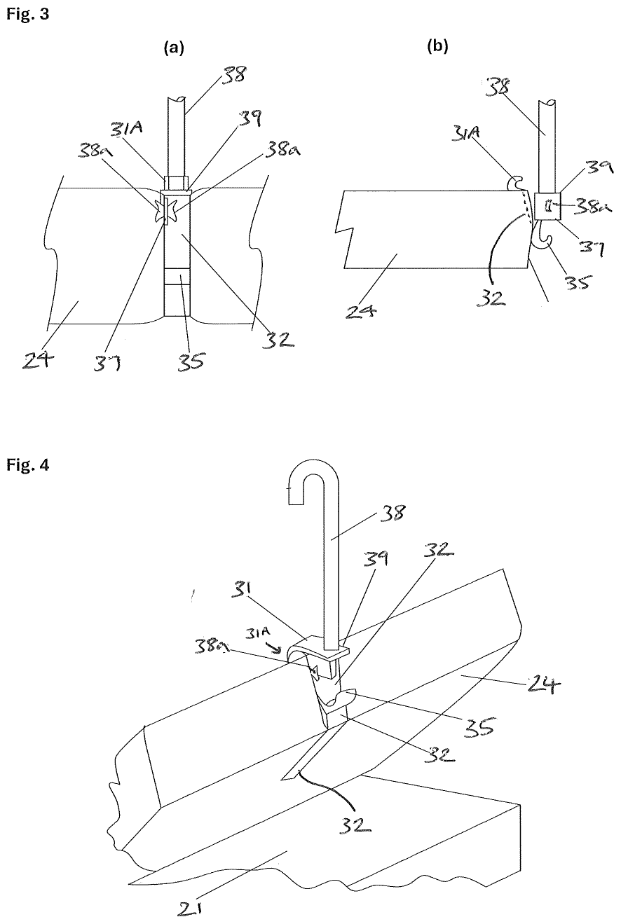

Referring to FIG. 3 subsections (a) and (b) and FIG. 4, pillow adjustment mechanism 10 has the same arrangement as described above. However, clamp 30 includes a further bracket 37 to which is connected a member 38 in the form of a stand supported by platform 39 of bracket 37 for holding and supporting a container for administration of a liquid to a patient, for example by intravenous (IV) administration. Such liquids may include saline or pharmaceuticals.

The member 38 may be adjusted to vertical position irrespective of the angle of inclination of rear section 24 of bed 20 by adjusting wing nuts 38a which connect member 38 to bracket 37.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A pillow adjustment mechanism comprising:
a replaceable sleeve for holding a pillow;
at least one strip connected to the replaceable sleeve; and
a clamp connected to the at least one strip and having connection means for connecting the clamp to a furniture item,
wherein the at least one strip is connected to the clamp at a selected position corresponding with a selected position of the pillow relative to the furniture item.

2. The pillow adjustment mechanism of claim 1, wherein said clamp has a frictional grip with the furniture item.

3. The pillow adjustment mechanism of claim 2, wherein the clamp has a degree of elasticity allowing it to be stretched to accommodate a portion of the furniture item and then spring back to provide a neat or interference fit to the furniture item.

4. The pillow adjustment mechanism of claim 3, wherein the at least one strip enables connection to the clamp at a plurality of selectable positions.

5. The pillow adjustment mechanism of claim 4, wherein the positions are fixed with the at least one strip being provided with a plurality of connectors to any one of which the clamp is fixable.

6. The pillow adjustment mechanism of claim 5, wherein the sleeve is connected to the at least one strip by co-operation of a connector disposed on the at least one strip and a complementary connector disposed on the sleeve, the sleeve being provided with reinforcement to provide strengthening at the complementary connector.

7. The pillow adjustment mechanism of claim 5, wherein the at least one strip is flexible allowing a small range of movement, on the order of centimetres, for the pillow.

8. The pillow adjustment mechanism of claim 7, wherein the at least one strip is disposed at an angle to the horizontal corresponding to the angle at which the furniture item or section of the furniture item is inclined.

9. The pillow adjustment mechanism of claim 8, wherein the at least one strip is disposed at 0 to 75 degrees to a horizontal plane.

10. The pillow adjustment mechanism of claim 9, wherein the clamp comprises at least one fitting, for example at least one hook, enabling connection of a member selected from the group consisting of a cable or tube forming part of a therapeutic system.

11. The pillow adjustment mechanism of claim 10, wherein the member is a support for a container for administration of a liquid to a patient.

12. The pillow adjustment mechanism of claim 10, wherein the clamp includes a bracket for mounting the member.

13. The pillow adjustment mechanism of claim 12, wherein adjustment means are provided for fixing the member in vertical position irrespective of the angle of inclination of the furniture item or furniture item section.

14. The pillow adjustment mechanism of claim 5, wherein the furniture item is a hospital bed.

15. A furniture item comprising:
a body having a rear section movable to a determined angle, the rear section having a front surface and a rear surface; and
a pillow adjustment mechanism comprising:
a replaceable sleeve for holding a pillow;
at least one strip connected to the replaceable sleeve; and
a clamp connected to the at least one strip and having connection means for connecting the clamp to the body,
wherein the at least one strip is connected to the clamp at a selected position corresponding with a selected position of the pillow relative to the furniture item.

16. The furniture item of claim 15, being a hospital bed and wherein the body is a mattress.
